(19) United States
(12) Patent Application Publication
(10) Pub. No.: US 2026/0331000 A1
(43) Pub. Date: Oct. 22, 2026

(54) BONE IMPLANT MODEL

(71) Applicant: UNIFORMED SERVICES UNIVERSITY OF THE HEALTH SCIENCES, Bethesda, MD (US)

(72) Inventors: Tyler Scott Kemerer, Bethesda, MD (US); Bruce Doll, Bethesda, MD (US); Caitlin Darcey, Severna Park, MD (US); John Wilson, Bethesda, MD (US)

(21) Appl. No.: 19/634,903

(22) Filed: Mar. 31, 2026

Related U.S. Application Data
(60) Provisional application No. 63/791,878, filed on Apr. 21, 2025.

(51) Int. Cl. G09B 23/28

(52) U.S. Cl. CPC G09B 23/283

(57) ABSTRACT

A bone implant model for assisting with an implant procedure includes a base and an insert. The base includes a support surface and a projection that extends from the support surface. The projection includes a first region, a second region, and a gap formed between the first and second regions. The insert is removably coupled to the base and can be positioned within the gap. The insert includes a first section having a first density and a second section having a second density greater than the first density.

### CROSS-REFERENCE TO RELATED APPLICATION

The present disclosure claims the benefit of U.S. Provisional Application No. 63/791878, filed Apr. 21, 2025, the contents of which is incorporated herein by reference in its entirety.

### GOVERNMENT INTEREST

The disclosure described herein may be manufactured, used and licensed by or for the U.S. Government.

### FIELD

The present disclosure relates to an implant tool. More particularly, the present disclosure relates to an implant model for assisting with bone implants.

### BACKGROUND

Dental implants are becoming an increasingly popular treatment choice for the replacement one or more missing teeth, and it is estimated that about 2.5 to 5 million implants are placed each year in the US. In an edentulous site, the alveolar bone is comprised of cortical and cancellous bone. Cortical bone is much denser, stronger, and stiffer than cancellous bone. For example, cortical bone may have a hardness value of about 10% to about 20% higher than that of cancellous bone.

Surgically, implants can be placed freehand or guided. Freehand placement gives the clinician full intraoperative control over the location and angulation of the implant, which are based on adjacent teeth and anatomical landmarks. Guided placement utilizes various methods to translate an extraorally planned implant location to the actual intraoral location of the implant. Guided implant surgery encompasses a wide spectrum of methods including non-restrictive guides (e.g., clear vacuform stent), static guides, dynamic navigation (e.g., X-Nav), and robotically assisted placement.

Free-hand implant placement is less accurate than partially and fully guided implant placement. However, there is still some degree of inaccuracy that exists in all methods. For example, the varying bone densities at an edentulous site may cause angular deviations when the implant is inserted into a patient's mouth. Therefore, there is a great need for dental implant placement training, research, and patient simulation.

### SUMMARY

Various examples of the present disclosure can overcome various of the aforementioned and other disadvantages associated with known terminal connectors and offer new advantages as well.

In some forms, an implant model for assisting with an implant procedure. The implant model includes a first section having a first density and a second section having a second density greater than the first density.

In some forms, a bone implant model for assisting with an implant procedure includes a base and an insert. The base includes a support surface and a projection that extends from the support surface. The projection includes a first region, a second region, and a gap formed between the first and second regions. The insert is removably coupled to the base and can be positioned within the gap. The insert includes a first section having a first density and a second section having a second density greater than the first density.

In some forms, a dental implant model for assisting with static guided dental implants includes a base and an insert. The base includes a support surface, a first projection that extends from the support surface, and a second projection that extends from the support surface. The first projection has a first lower end coupled to the support surface and a first upper end opposite to the first lower end. The second projection has a second lower end coupled to the support surface and a second upper end opposite to the second lower end.

In some forms, there is a training kit for simulating a bone implant procedure. The kit includes a base and a plurality of interchangeable inserts. The base can removably receive a test insert at an implant site. The plurality of interchangeable inserts can be selected as the test insert and removably received by the base. Each interchangeable insert is integrally formed as a one-piece body by additive manufacturing from a single material and including a drillable portion having (i) a solid outer region and (ii) an internal region of lower density than the solid outer region by virtue of a webbed internal structure of the single material. The plurality of interchangeable inserts includes at least a first insert and a second insert that differ from one another in at least one of: (a) a ratio of the internal region to the solid outer region, (b) a location of the internal region within the drillable portion, or (c) an infill percentage of the internal region. Different ones of the interchangeable inserts simulate different bone conditions at the implant site.

In some forms, a method of performing a simulated implant procedure includes providing a first insert with a first section that has a first density and a second section that has a second density greater than the first density. The method also includes providing a second insert with a third section that has a third density and a fourth section that has a fourth density greater than the third density. The method also includes selecting one of the first insert and the second insert and connecting the selected one of the first insert and the second insert adjacent to a projection on a base. The method further includes performing a drilling operation into the selected one of the first insert and the second insert. The first density and the third density are representative of cancellous bone and wherein the second density and the fourth density are representative of cortical bone.

In some forms, there is a method of creating a patient-specific training insert for a simulated dental implant procedure. A scan data (e.g., established using cone beam computed tomography) of a patient's mouth is obtained. A relative amount of cancellous bone and cortical bone at an edentulous site is determined from the scan data. An internal structure and a relative arrangement of a solid outer portion and a webbed interior portion of a removable training insert is selected to approximate the determined relative amount. The removable training insert is manufactured as a one-piece body from a single thermoplastic material.

In some examples, the implant procedure may be a dental implant procedure or an orthopedic implant procedure.

The disclosure herein should become evident to a person of ordinary skill in the art given the following enabling description and drawings. The drawings are for illustration purposes only and are not drawn to scale unless otherwise indicated. The drawings are not intended to limit the scope of the disclosure. The following enabling disclosure is directed to one of ordinary skill in the art and presupposes that those aspects within the ability of the ordinarily skilled artisan are understood and appreciated.

### BRIEF DESCRIPTION OF THE DRAWINGS:

Various aspects and advantageous features of the present disclosure will become more apparent to those of ordinary skill when described in the detailed description of preferred examples and reference to the accompanying drawings wherein:

FIG. 1 is a perspective view of an implant model.

FIG. 2 is a perspective view of a base of the implant model of FIG. 1.

FIG. 3 is a perspective view of a first insert of the implant model of FIG. 1.

FIG. 4 is a top view of the first insert of FIG. 3.

FIG. 5 is a cross-sectional view of the first insert of FIG. 3, viewed along section 5—5.

FIG. 6 is a perspective view of a first insert of the implant model of FIG. 1.

FIG. 7 is a top view of the first insert of FIG. 6.

FIG. 8 is a cross-sectional view of the first insert of FIG. 6, viewed along section 8—8.

FIG. 9 is a top view of a surgical guide coupled to the implant model of FIG. 1.

### DETAILED DESCRIPTION:

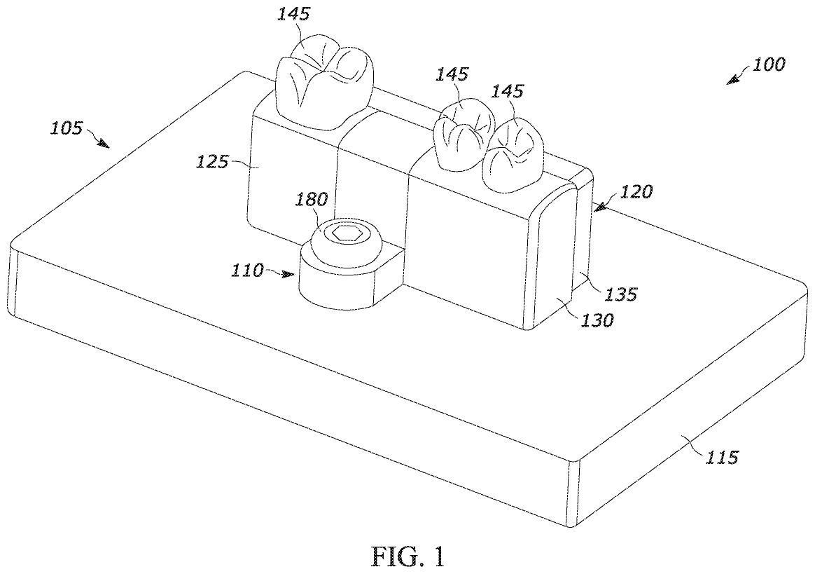

FIG. 1 illustrates an implant model 100 that may be used by a clinician to simulate a dental implant osteotomy site. The implant model 100 may include a base 105 and an insert 110. As described in more detail below, a clinician may customize the implant model 100 by utilizing different inserts 110 to simulate different percentages of cortical bone and cancellous bone at an osteotomy site.

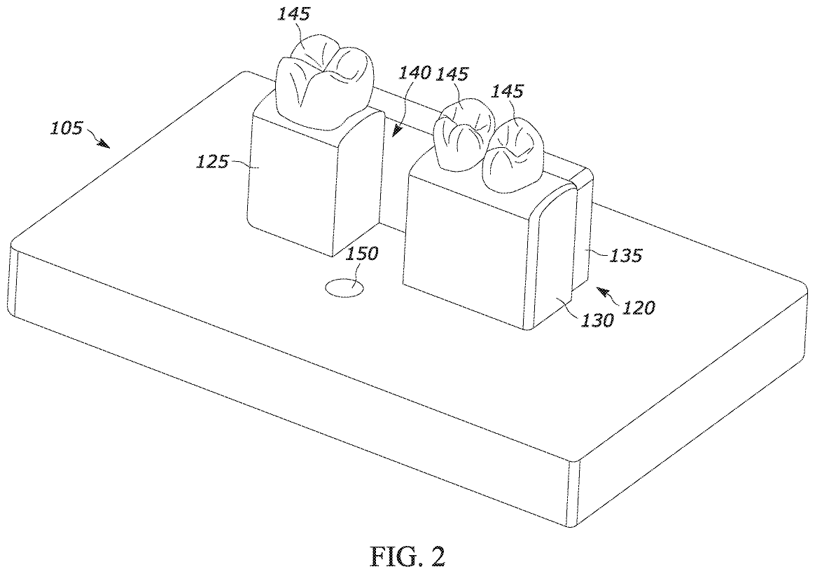

As shown in FIG. 2, the base 105 may include a lower support 115 and a projection 120 that extends from the lower support 115. In the illustrated example, the lower support 115 may be formed from a rigid material (e.g., plastic, metal, wood, etc.) and may have a substantially rectangular perimeter, although other examples may have different shapes (e.g., circular, elliptical, triangular, etc.). The projection 120 may extend substantially perpendicularly from a surface of the lower support 115. However, in other examples, the projection 120 may extend at a different angle relative to the surface of the lower support 115. The lower support 115 of the base 105 may provide support for the projection 120 without any further support structures. As described in more detail below, this may enable the implant model 100 to be used without additional hardware (e.g., a phantom head).

In some forms, the projection 120 may be formed from a rigid material (e.g., plastic, metal, wood, etc.) and may be a single body. The rigid material may be, although does not have to be, the same material as the lower support 115. In other examples, the projection 120 may be one of multiple and discontinuous projections 120 that extend from the surface of the lower support 115.

With continued reference to FIG. 2, the illustrated projection 120 may include a first section 125, a second section 130, and a connector 135 that extends between the first and second sections 125, 130. The first section 125 may be at least partially spaced apart from the second section 130 thereby forming a gap 140 between the first and second sections 125, 130. The connector 135 may be positioned against the surface of the lower support 115 and extend along a side surface of each of the first and second sections 125, 130. The connector 135 may also extend at least partially along an opening to the gap 140. As described in more detail below, the connector 135 may serve as a stop for the insert 110.

In the illustrated example, one or more protrusions 145 may extend from the upper surface of the projection 120. For example, one protrusion 145 may extend from the first section 125 and a pair of protrusions 145 may extend from the second section 130. The protrusions 145 may be sized and shaped to represent the shape of human teeth. For example, the protrusions 145 may be sized and positioned to replicate the positioning of teeth 18, 20, and 21. The gap 140 may represent the location of missing tooth 19. However, other examples may include a different number of protrusions 145 and/or represent a different set of teeth.

In some forms, the lower support 115 may include an aperture 150. The aperture 150 may extend through the surface of the lower support 115 and may be disposed outside of the gap 140 and in line with the gap 140. For example, the aperture 150 may be positioned between the first and second sections 125, 130 and disposed along the surface of the lower support 115 in a direction substantially perpendicular to the direction between the first and second sections 125, 130.

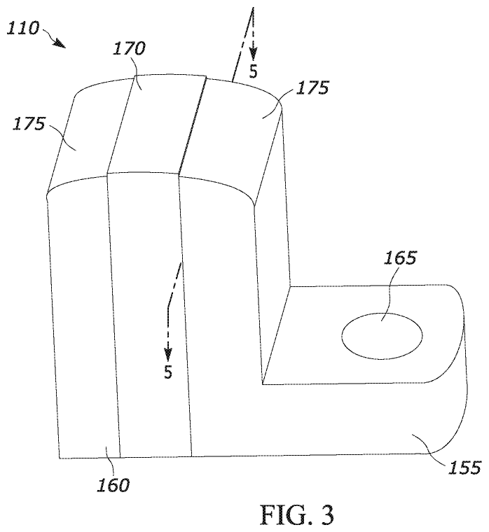

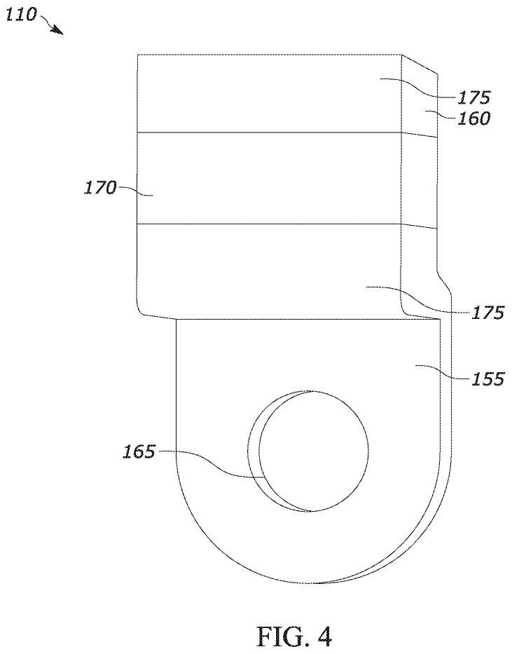

As shown in FIGS. 3 and 4, the insert 110 may include a base section 155 and an extension 160 that extends from the base section 155. In some forms, the base section 155 and the extension 160 may be formed from an at least partially rigid material (e.g., plastic). The base section 155 and the section 160 may be formed integrally as one piece (e.g., using additive manufacturing, injection molding, etc.). The illustrated example may be constructed out of a thermoplastic (e.g., polylactic acid) using additive manufacturing. Other examples may be formed from a different material (e.g., wood, metal, etc.) and/or may be constructed using a different method of manufacture (e.g., casting, stamping, extruding, machining, etc.).

In some forms, the extension 160 may be narrower than the base section 155 in at least one direction. For example, a portion of the base section 155 may extend beyond the extension 160. This portion of the base section 155 may include an aperture 165, which may be similarly sized and shaped to the aperture 150.

As shown in FIGS. 3 to 5, the extension 160 may include a first region 170 and a second region 175. In the illustrated example, the first region 170 may be formed in a middle of the extension 160 and may be at least partially surrounded (e.g., sandwiched) by the second region 175 (e.g., on either side of the first region 170). For example, the area of each second region 175 may be the same so that the first region 170 is centered on the extension. However, in other examples, the position and/or size of the first and second regions 170, 175 may be different and/or there may be more than two regions (e.g., three, four, etc.).

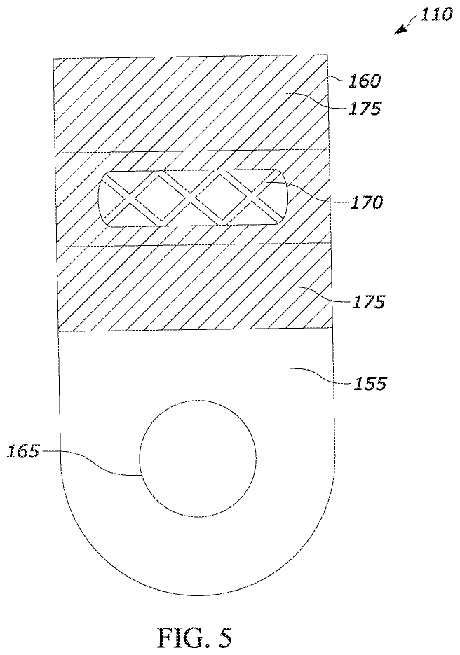

As shown in FIG. 5, the first region 170 may be at least partially hollow (e.g., an about 25% infill) in a center of the extension 160. For example, the first region 170 may be formed with a solid outer region (e.g., extending about 1 mm down from an upper surface) and a webbed interior below the solid outer region that creates the partially hollow interior. The solid outer region may represent cortical bone that is present along a crest of an edentulous ridge and the webbed interior may replicate cancellous bone. The second region 175 may be formed with a solid center (e.g., an about 100% infill), which may replicate cortical bone. The second region 175 and the solid (i.e., not webbed) portion of the first region 170 may have substantially the same properties (e.g., substantially the same density).

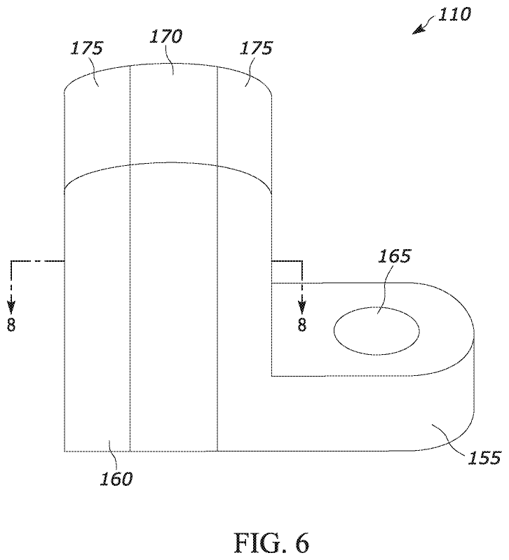

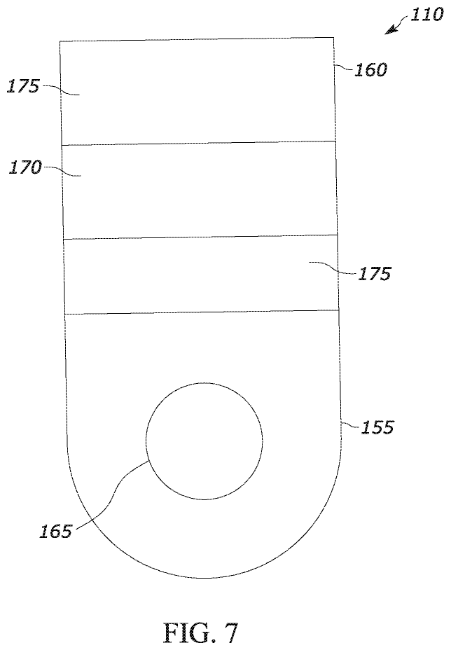

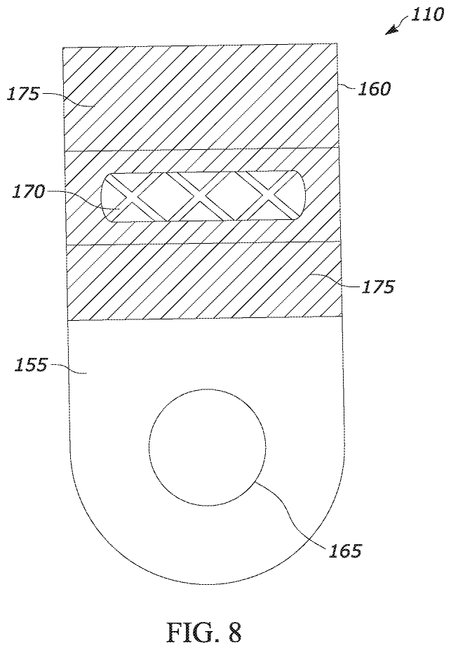

FIGS. 6 to 8 illustrate an alternate example of an insert 110 where the size of the first and second regions 170, 175 are different than the size of the first and second regions 170, 175 in FIGS. 3 to 5. For example, the first region 170 (e.g., representing the cancellous bone) in the insert 110 illustrated in FIG. 6 may be smaller in the first region 170 illustrated in FIG. 3. Conversely, the total combined area of the second region 175 (e.g., representing the cortical bone) in the insert 110 illustrated in FIG. 6 may be larger in the second region 175 illustrated in FIG. 3. Additionally, the illustrated second regions 175 may not have equal areas so that the first region 170 is not centered on the extension 160. However, as previously explained, inserts 110 may be constructed with first and second regions 170, 175 (or further numbered regions) of any shape or size in order to replicate different types of bones (or other tissues) as understood by a person of ordinary skill in the art.

Returning to FIG. 1, a clinician may select one of the inserts 110 and position it in the gap 140. For example, the insert 110 may be oriented so that the extension 160 is positioned within the gap 140 between the first and second sections 125, 130. The insert 110 may extend into the gap 140 until it contacts the connector 135. The connector 135 may act as a stop to limit the movement into the gap 140 (e.g., to help properly position the insert 110). When the extension 160 contacts the connector 135, the base section 155 may be disposed outside of the gap 140 so that the aperture 165 is aligned with the aperture 150 of the base 105. A fastener 180 may be inserted through the apertures 150, 165 to secure the insert 110 to the base 105. In other examples, one or more other connection methods may be used instead of or in addition to the mechanical fastener 180. For example, the insert 110 could connect to the base 105 using magnets, an adhesive, a snap fit, a press fit, and/or a friction fit.

The clinician may select an insert 110 to connect to the base 105 based on a specific use case. In some examples, inserts 110 may be manufactured with a predetermined ratio of the first region 170 to the second region 175. A clinician may select an insert 110 with a specific ratio to practice performing an implant procedure on a region of the patient with a similar ratio of cancellous bone to cortical bone (e.g., 0:100, 25:75, 50:50, 75:25, and 100:0). In this example, the relative size of the first and second regions 170, 175 may change to correspond to the desired ratio (e.g., the first and second regions 170, 175 may have an equal size in a 50:50 ratio). In other examples, a patient may be analyzed (e.g., by taking an X-ray or other scan (e.g., via cone beam computed tomography (CBCT)) of the patient's mouth) before a procedure to determine an exact ratio of cancellous bone to cortical bone and the insert 110 may be manufactured (e.g., using additive manufacturing) to approximate the ratio in the specific patient. In some example, the infill percentage of the first region 170 of one insert may be different than an infill percentage of the first region 170 in another insert. The location of the first and second regions 170, 175 may also be different than the examples shown in FIGS. 3 to 8 to simulate other conditions (e.g., some examples could include a first and second region 170, 175 in the same vertical plane as viewed in FIG. 3 or 6). The clinician may quickly make a custom insert for a specific patient and may use this insert to prepare for a procedure on that individual patient.

In certain forms, an analysis of the patient's mouth (or other part of the body) may reveal other anatomical features or conditions. For example, a CBCT scan of a patient's mouth may reveal locations of nerves, sinus cavities, or other intrabony findings. This information can also be used when forming the custom insert 110. Specifically, it may be helpful to construct an insert 110 replicating a “non-ideal” site so that a clinician can gain practice avoiding a nerve or other obstacle potential present at an insertion site.

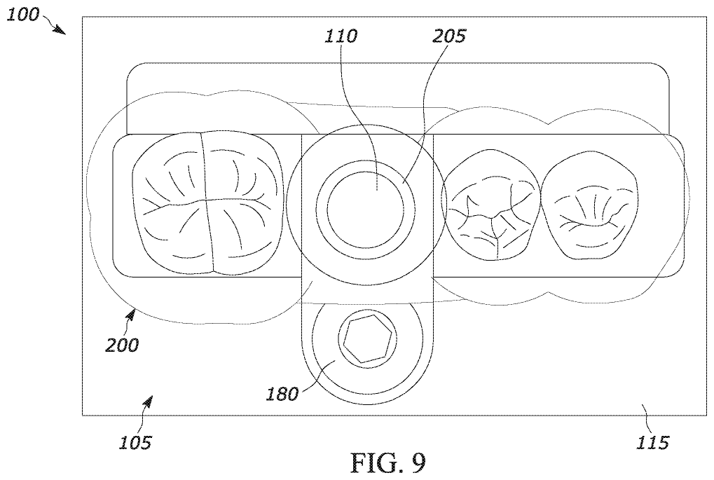

As shown in FIG. 9, a surgical guide 200 may be placed over the projection 120. For example, the surgical guide 200 may engage the protrusions 145. The insert 110 does not include a protrusion 145 to simulate a missing tooth. The surgical guide 200 includes an opening 205 positioned over the extension 160 of the insert 110. Once created, the densities of the inserts (e.g., in the first and second regions 170, 175) may be detectable on both 2D and 3D x-rays (or any other method of scanning), to help plan the implant location and subsequently design/fabricate the surgical guide 200 (e.g., if there is a custom surgical guide constructed).

In use, the clinician may drill into the extension 160 through the hole 205 of the surgical guide 200 to simulate an implant procedure. The webbed structure of the first region 170 and the solid structure of the second region 175 may replicate a clinician drilling into cancellous bone and cortical bone respectively, which can provide practice and increase effectiveness of the actual procedure. In other words, the non-uniform cross section of the insert 110 may more closely replicate the patient's bone to provide the clinician with a more realistic practice scenario. The clinician may use the implant model 100 in a variety of scenarios without reliance on external hardware. For example, because the base 105 is self-supporting and can support the insert 110, the base 105 and/or insert 110 does not need to be installed into a further component. This may provide the clinician with more freedom to use the implant model 100 because a worksite is not limited by where another piece of hardware (e.g., a phantom mouth) can be positioned.

In other examples, the clinician may drill into the extension 160 without the assistance of the guide 200. For example, the clinician may simulate an implant procedure using another method, including freehand, dynamic navigation, and/or robotically assisted implant placement.

In certain forms, the insert 110 may include a sensor (not shown) that may be positioned within the extension 160. The sensor may be a temperature sensor, a pressure sensor, a position sensor, a photosensor, a vibrational sensor, or any similar type of sensor. The sensor may wirelessly communicate (e.g., via Bluetooth, WiFi, RF, etc.) a reading to a processor (e.g., in a computer, in a smart phone, etc.). The clinician may use the measured data from the sensor to further inform whether the implant procedure performed on the insert was successful. For example, pressure or temperature measurements that exceed a predetermined threshold may be indicative of an unsuccessful procedure, while pressure or temperature measurements that remain below the threshold may be indicative of a successful procedure. In some examples, the processor may be preprogrammed with the thresholds, which may be specific for a specific type of procedure and/or a specific type of bone. In other examples, the clinician may be able to set the processor with the desired threshold. The clinician may use this data to adjust their technique when performing the procedure on a subsequent insert 110 or on a patient.

In one form, the processor may collect data from the sensor and can output the data via a display. For example, a smart phone app may collect data from the sensor and output the data in a user-readable way. This could include a graphical representation of the measured value over time in comparison to the threshold so that the clinician can check their performance relative to the threshold and can determine when they exceeding the threshold.

In one form, an external device, the base 105, and/or the insert 110 may provide real-time outputs to the clinician. For example, the external device (e.g., smart phone, smart watch, etc.) may output an alert (e.g., a push notification) alerting the user that a threshold was excited. Similarly, the base 105 and/or the insert 110 may include an output device (e.g., a light, a speaker, etc.) that can provide an alert (e.g., a visual, auditory, tactile, etc.) that the threshold was exceeded. This can allow the clinician to see in real time what actions caused the threshold to be exceeded.

After the clinician has performed the practice procedure using the selected insert 110, the clinician may decouple the insert 110 from the base 105 and remove the insert 110 from the gap 140. The clinician may then replace the used insert 110 with a new insert, which may or may not include the same ratio of first region 170 to second region 175.

Although the above description is specifically related to the use of the implant model 100 in a dental procedure, one of ordinary skill in the art would understand that the implant model 100 could similarly be used on other types of procedures. For example, bones throughout the body have cancellous and cortical regions. Clinicians in other fields may similarly use the implant model 100 to practice performing orthopedic implants. In other uses, the shape of the base 105 may change to reflect the shape of the bone where the procedure will be performed. For example, the protrusions 145 (e.g., which represent teeth) may be removed for a non-dental application. However, the overall structure of the base 105 and the insert 110 may be similar and adapted into other applications.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various examples of the disclosure. Once armed with the present specification, routine experimentation is all that is needed to determine adjustments and modifications that will carry out the present disclosure.

The above examples are for illustrative purposes and are not intended to limit the scope of the disclosure or the adaptation of the features described herein. Those skilled in the art will also appreciate that various adaptations and modifications of the above-described preferred examples can be configured without departing from the scope and spirit of the disclosure. Therefore, it is to be understood that, within the scope of the appended claims, the disclosure may be practiced other than as specifically described.

1. A training kit for simulating a bone implant procedure, the training kit comprising:
a base configured to removably receive a test insert at an implant site; and
a plurality of interchangeable inserts each configured to be selected as the test insert and removably received by the base, each interchangeable insert being integrally formed as a one-piece body from a single material and including a drillable portion having (i) a solid outer region and (ii) an internal region of lower density than the solid outer region by virtue of a webbed internal structure of the single material;
wherein the plurality of interchangeable inserts includes at least a first insert and a second insert that differ from one another in at least one of:
(a) a ratio of the internal region to the solid outer region,
(b) a location of the internal region within the drillable portion, or
(c) an infill percentage of the internal region,
such that different ones of the interchangeable inserts simulate different bone conditions at the implant site.

2. The training kit of claim 1, wherein the base includes a support surface and a projection extending from the support surface, the projection defining a gap configured to receive the insert, wherein the projection includes a connector positioned to contact the insert and act as a stop during insertion of the insert into the gap, and wherein the base includes a first aperture and each insert includes a second aperture alignable with the first aperture to receive a fastener that secures the insert to the base.

3. (canceled)

4. (canceled)

5. The training kit of claim 1, wherein the plurality of interchangeable inserts comprises inserts corresponding to different predetermined cancellous-bone-to-cortical-bone ratios.

6. The training kit of claim 1, wherein the first insert and the second insert have different infill percentages in their respective internal regions.

7. The training kit of claim 1, wherein at least one of the interchangeable inserts includes more than two regions having different internal structures.

8. A bone implant model for assisting with an implant procedure, the bone implant model comprising:
a base including a support surface and a projection extending from the support surface, wherein the projection includes a first region, a second region, and a gap formed between the first and second regions; and
an insert removably coupled to the base and configured to be positioned within the gap, wherein the insert includes a first section having a first density and a second section having a second density greater than the first density.

9. The bone implant model of claim 8, wherein the base includes a first aperture and the insert includes a second aperture, wherein the first aperture is aligned with the second aperture when the insert is received within the gap, and wherein the aligned first aperture and second aperture are configured to receive a fastener to secure the insert to the base.

10. The bone implant model of claim 8, wherein the insert is constructed using additive manufacturing and the first section and the second section are constructed from the same material.

11. The bone implant model of claim 10, wherein the first section is at least partially formed with a webbed pattern and the second section is solid.

12. The bone implant model of claim 8 , wherein the first section is disposed between a pair of second sections.

13. The bone implant model of claim 8 , wherein the first region includes a first protrusion and the second region includes a second protrusion, wherein the first protrusion and the second protrusion are shaped like human teeth.

14. A method of performing a simulated dental implant procedure, the method comprising,
providing a first insert having a first section having a first density and a second section having a second density greater than the first density;
providing a second insert having a third section having a third density and a fourth section having a fourth density greater than the third density;
selecting one of the first insert and the second insert;
connecting the selected one of the first insert and the second insert adjacent to a projection on a base; and
performing a drilling operation into the selected one of the first insert and the second insert;
wherein the first density and the third density are representative of cancellous bone and wherein the second density and the fourth density are representative of cortical bone.

15. The method of claim 14, wherein the first density is the same as the third density and wherein the second density is the same as the fourth density.

16. The method of claim 14, wherein the first section has a webbed cross section and the second section has a solid cross section.

17. The method of claim 14, further comprising cone beam computed tomography (CBCT) scanning a patient's mouth to determine ratio of cancellous bone to cortical bone in an edentulous site, and constructing the first insert with a ratio of the first section to the second section being the same as the determined ratio.

18. The method of claim 17, wherein the first insert is constructed using additive manufacturing.

19. The method of claim 14, further comprising removing the selected one of the first insert and the second insert from the base, and connecting an additional insert to the base, wherein the additional insert has properties of either the first insert or the second insert.

20. The method of claim 14, further comprising aligning a first aperture of the selected one of the first insert and the second insert with a second aperture of the base, and inserting a fastener through the first aperture and the second aperture.

21. The method of claim 14, wherein the projection includes a discontinuity forming a gap, the method further comprising positioning the selected on the first insert and the second insert within the gap.

22.-27. (canceled)
